(19) United States
(12) Patent Application Publication
(10) Pub. No.: US 2026/0084738 A1
(43) Pub. Date: Mar. 26, 2026

(54) AUTOMOTIVE REPAIR ASSIST CART

(71) Applicant: SJB Industrial Supply, Wentzville, MO (US)

(72) Inventor: Scott Boettler, Lake St. Louis, MO (US)

(21) Appl. No.: 19/340,088

(22) Filed: Sep. 25, 2025

Related U.S. Application Data
(60) Provisional application No. 63/699,313, filed on Sep. 26, 2024.

(51) Int. Cl. B62B 3/10; B25H 5/00; B62B 3/02

(52) U.S. Cl. CPC B62B 3/104; B25H 5/00; B62B 3/02; B62B 2202/02; B62B 2202/48; B62B 2203/30; B62B 2203/70

(57) ABSTRACT

An automotive repair assist cart configured to centralize oil changing equipment and processes, to eliminate service wastes and hazards associated with material handling and movement, thereby optimizing oil changes, is disclosed herein. The automotive repair assist cart comprises a cart frame including storage features such as shelving and tool holders and a drain tray, a drain tray coupler assembly, an fluid retention tank mount, an oil drain tank assembly, a parts washer mount, and a removable parts washer. The drain tray is configured to permit oil drained from parts contained therein into the oil drain tank assembly via the drain tray coupler assembly. The oil drain tank assembly is configured to catch oil drained from a vehicle and is mounted on. the cart frame with the fluid retention tank mount. The removable parts washer is configured for washing parts therein, and is mounted to the cart frame with the parts washer mount.

### CROSS-REFERENCE TO RELATED APPLICATIONS

This application claims the benefit of U.S. Provisional Application No. 63/699,313, filed on Sep. 26, 2024, which relates to U.S. Provisional Application No. 63/654,384, filed on May 31, 2024. The disclosure of the above application(s) is/are incorporated herein by reference in its/their entirety.

### FIELD

The present disclosure generally relates to oil changing equipment and more particularly to an automotive repair assist cart for storing oil changing equipment thereon.

### BACKGROUND

Automotive maintenance such as oil changes are an essential part of vehicle maintenance and are generally performed every few thousand miles driven by a vehicle. For example, overtime oil within a vehicle degrades due to unavoidable factors such as heat and pressure. Such degradation introduces contaminants to the oil that can be harmful to the vehicle. Hence, oil changes are routinely performed to replace potentially harmful old oil in a vehicle with new oil. During an oil change, existing oil is drained from a vehicle and replaced with new oil. To this end, oil changes include several steps including preparation steps, part removal steps, part cleaning steps, and part replacement steps. Such steps require proper oil handling techniques to prevent messes and contamination and require a wide variety of tools. Moreover, conventional oil changing processes are typically messy, and include several service wastes and inefficiencies associated with material handling and motion. For example, during conventional oil changing processes, a mechanic travels back and forth between the vehicle, a toolbox, a cleaning station, and a disposal station which can lead to tool and part damages, spills, unnecessary work, exhaustion, disorganization, etc.

### SUMMARY

The present disclosure generally pertains to an automotive repair assist cart that overcomes the shortcomings of conventional oil changing processes. As will be explained in greater detail below, the automotive repair assist cart of the present disclosure is configured to centralize oil changing equipment and processes, to eliminate service wastes, inefficiencies and hazards associated with material handling and movement, thereby optimizing oil changes.

### BRIEF DESCRIPTION OF THE DRAWINGS

FIG. 1 is an image of an automotive repair assist cart, according to various embodiments of the present disclosure.

FIG. 2 is another image of the automotive repair assist cart shown in FIG. 1, according to various embodiments of the present disclosure.

FIG. 3 is another image of the automotive repair assist cart shown in FIGS. 1 and 2, according to various embodiments of the present disclosure.

FIG. 4 is another image of the automotive repair assist cart shown in FIGS. 1-3, according to various embodiments of the present disclosure.

FIG. 5 is another image of the automotive repair assist cart shown in FIGS. 1-4, according to various embodiments of the present disclosure.

FIG. 6 is another image of the automotive repair assist cart shown in FIGS. 1-5, according to various embodiments of the present disclosure.

FIG. 7 is another image of the automotive repair assist cart shown in FIGS. 1-6, according to various embodiments of the present disclosure.

FIG. 8 is a perspective of a cart frame that can be used with the automotive repair assist cart, according to various embodiments of the present disclosure.

FIG. 9A is an image of a drain tray coupler assembly that can be used with the automotive repair assist cart, according to various embodiments of the present disclosure.

FIG. 9B is another image of the drain tray coupler assembly shown in FIG. 9A that can be used with the automotive repair assist cart, according to various embodiments of the present disclosure.

FIG. 10 is another image of the automotive repair assist cart shown in FIGS. 1-7, according to various embodiments of the present disclosure.

FIG. 11 is an exploded view of an oil drain tank assembly that can be used with the automotive repair assist cart, according to various embodiments of the present disclosure.

FIG. 12A is an image of an fluid retention tank mount that can be used with the automotive repair assist cart, according to various embodiments of the present disclosure.

FIG. 12B is an image of a drain pan assembly mount that can be used with the automotive repair assist cart, according to various embodiments of the present disclosure.

FIG. 13 is an exploded view of a removable parts washer that can be used with the automotive repair assist cart, according to various embodiments of the present disclosure.

FIG. 14A is an image of a parts washer mount that can be used with the automotive repair assist cart, according to various embodiments of the present disclosure.

FIG. 14B is an image of the automotive repair assist cart shown in FIGS. 1-7, according to various embodiments of the present disclosure.

FIG. 15A is a side view of the automotive repair assist cart according to various other embodiments of the present disclosure.

FIG. 15B is an opposing side view of the automotive repair assist cart shown in FIG. 15A according to various embodiments of the present disclosure.

FIG. 15C is a top view of the automotive repair assist cart shown in FIGS. 15A and 15B according to various embodiments of the present disclosure.

FIG. 16 is an illustration of the removable parts washer shown in FIGS. 1, 6, 7, 13, 15A and 15B, wherein the removable parts washer includes a removable pump filter according to various embodiments of the present disclosure.

FIG. 17 is an illustration of the removable pump filter disconnected from a pump of the removable parts washer according to various embodiments of the present disclosure.

FIG. 18 is an illustration of the pump of the removable parts washer having the removable pump filter removed according to various embodiments of the present disclosure.

FIG. 19 is an illustration of a connecting end of the removable pump filter according with various embodiments of the present disclosure.

FIG. 20 is an illustration of a battery powered light of the automotive repair assist cart according to various embodiments of the present disclosure.

Corresponding reference characters indicate corresponding parts throughout the drawings.

### DETAILED DESCRIPTION

The following description is merely exemplary in nature and is in no way intended to limit the present teachings, application, or uses. Throughout this specification, like reference numerals will be used to refer to like elements. Additionally, the embodiments disclosed below are not intended to be exhaustive or to limit the invention to the precise forms disclosed in the following detailed description. Rather, the embodiments are chosen and described so that others skilled in the art can utilize their teachings. As well, it should be understood that the drawings are intended to illustrate and plainly disclose presently envisioned embodiments to one of skill in the art, but are not intended to be manufacturing level drawings or renditions of final products and may include simplified conceptual views to facilitate understanding or explanation. As well, the relative size and arrangement of the components may differ from that shown and still operate within the spirit of the invention.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

When an element, object, device, apparatus, component, region or section, etc., is referred to as being “on”, “engaged to or with”, “connected to or with”, or “coupled to or with” another element, object, device, apparatus, component, region or section, etc., it can be directly on, engaged, connected or coupled to or with the other element, object, device, apparatus, component, region or section, etc., or intervening elements, objects, devices, apparatuses, components, regions or sections, etc., can be present. In contrast, when an element, object, device, apparatus, component, region or section, etc., is referred to as being “directly on”, “directly engaged to”, “directly connected to”, or “directly coupled to” another element, object, device, apparatus, component, region or section, etc., there may be no intervening elements, objects, devices, apparatuses, components, regions or sections, etc., present. Other words used to describe the relationship between elements, objects, devices, apparatuses, components, regions or sections, etc., should be interpreted in a like fashion (e.g., “between” versus “directly between”, “adjacent” versus “directly adjacent”, etc.).

As used herein the phrase “operably connected to” will be understood to mean two are more elements, objects, devices, apparatuses, components, etc., that are directly or indirectly connected to each other in an operational and/or cooperative manner such that operation or function of at least one of the elements, objects, devices, apparatuses, components, etc., imparts or causes operation or function of at least one other of the elements, objects, devices, apparatuses, components, etc. Such imparting or causing of operation or function can be unilateral or bilateral.

As used herein, the term “and/or” includes any and all combinations of one or more of the associated listed items. For example, A and/or B includes A alone, or B alone, or both A and B.

Although the terms first, second, third, etc. can be used herein to describe various elements, objects, devices, apparatuses, components, regions or sections, etc., these elements, objects, devices, apparatuses, components, regions or sections, etc., should not be limited by these terms. These terms may be used only to distinguish one element, object, device, apparatus, component, region or section, etc., from another element, object, device, apparatus, component, region or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) taught herein, and because many modifications may be made in the embodiments described herein, it is to be understood that the details herein are to be interpreted as illustrative and non-limiting.

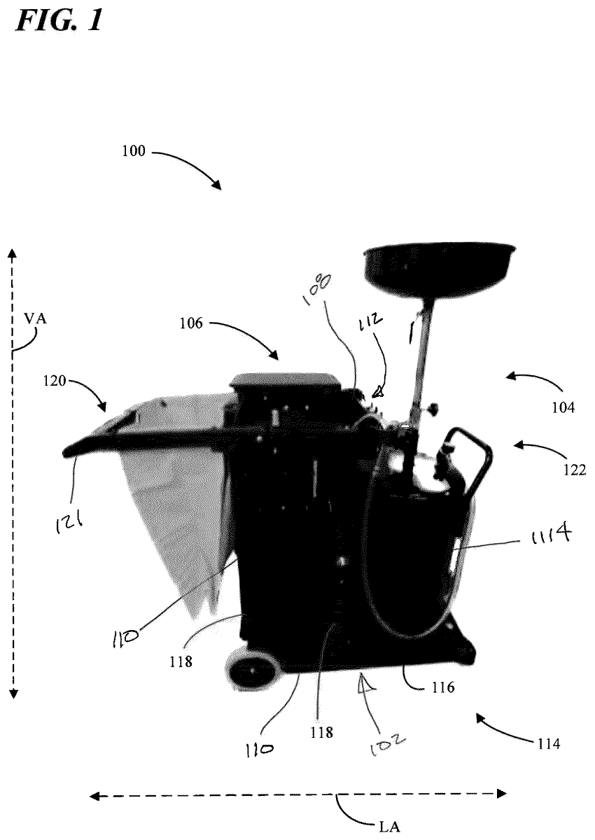

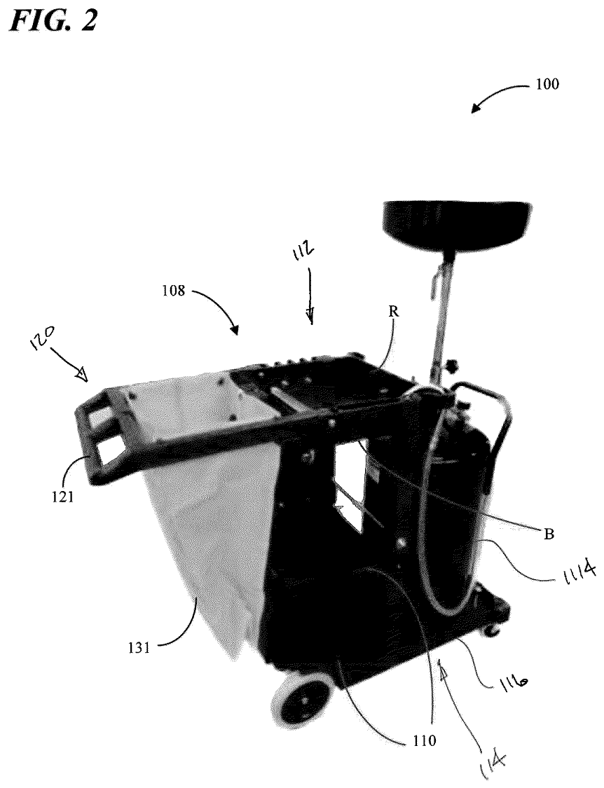

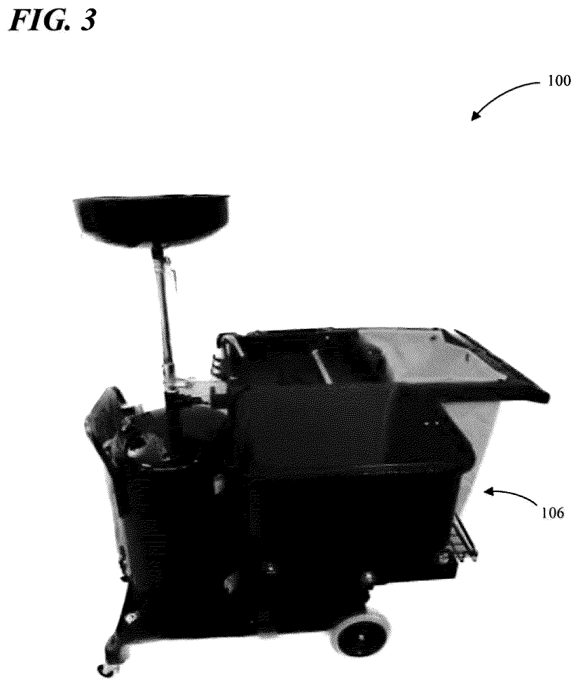

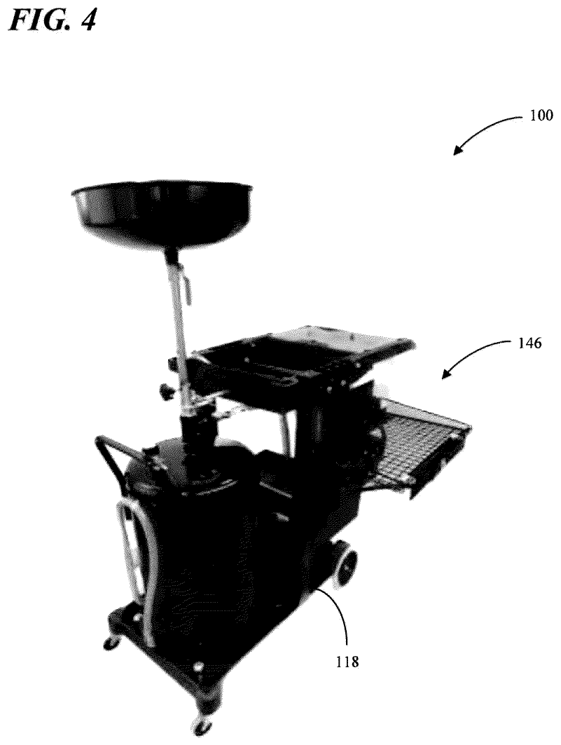

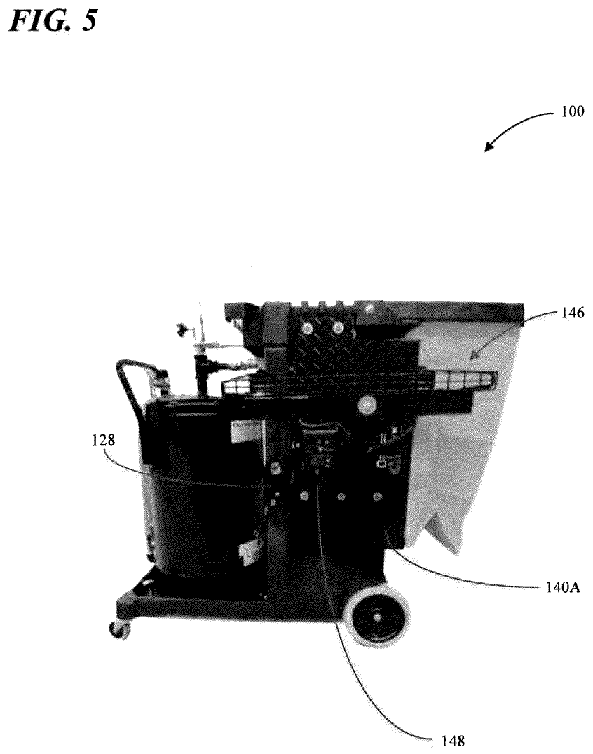

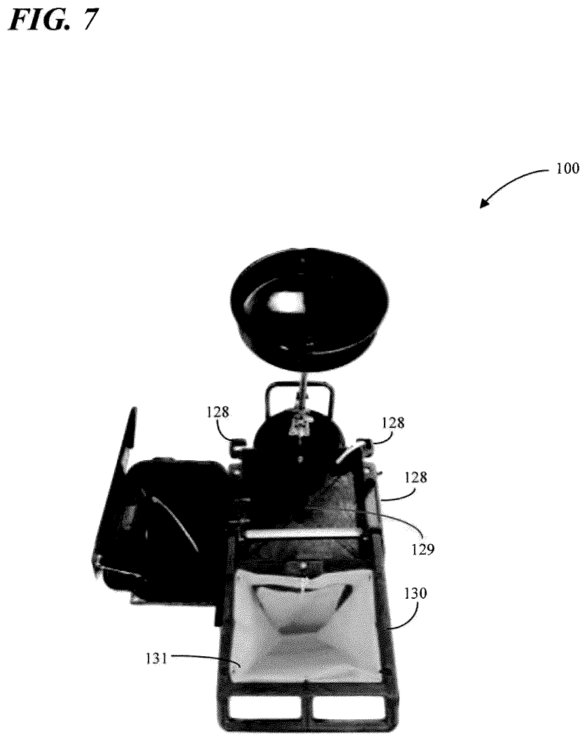

Referring now to FIGS. 1-7, an exemplary automotive repair assist cart 100 in accordance with various embodiments of the present disclosure is generally indicated at reference number 100. The automotive repair assist cart 100 broadly comprises a cart frame 102 that is configured to support automotive repair equipment, e.g., oil changing equipment, thereon, so that a mechanic has everything they need for a particular automotive repair, e.g., changing a vehicle's oil, in a mobile central location. In an exemplary embodiment, the automotive repair assist cart 100 is configured for securely mounting an oil drain tank assembly 104 thereon. The oil drain tank assembly 104 is configured to catch oil drained from a vehicle. Moreover, the automotive repair assist cart 100 is configured for supporting a removable parts washer 106 thereon. The removable parts washer 106 is configured for washing parts therein. The automotive repair assist cart 100 also includes a drain tray 108 configured for catching oil drained from parts removed from the vehicle such as oil filters. Additionally, the automotive repair assist cart 100 can comprise one or more additional trays 110 configured for storing and organizing automotive repair tools and equipment, e.g., oil changing tools and equipment, thereon. Individual components of the automotive repair assist cart 100 will now be described before turning to an exemplary method of forming the automotive repair assist cart 100.

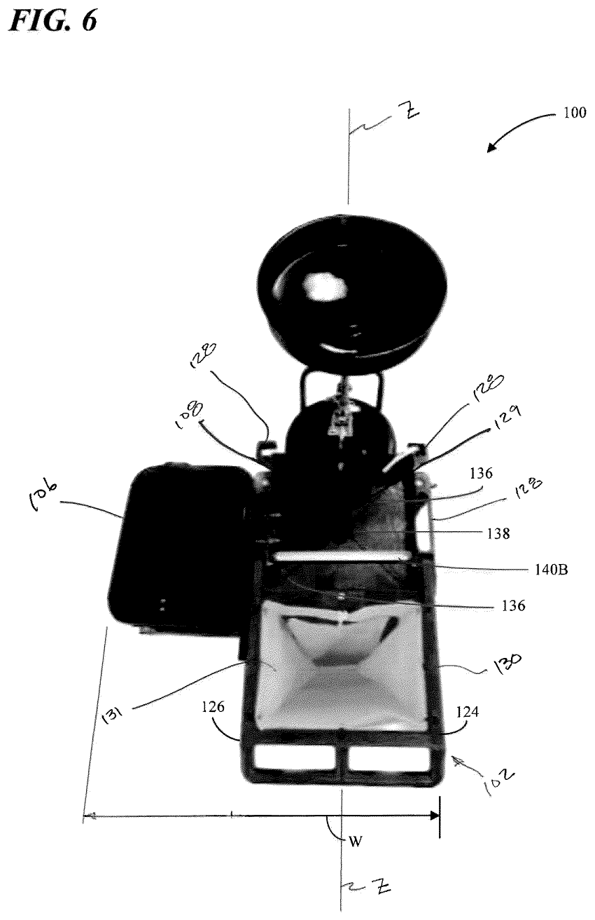

The automotive repair assist cart 100 comprises a frame 102 that includes a base 116 with a plurality of vertical legs 118 between the base 116 and a cart top portion 112. The cart top portion 112 is spaced apart from a cart bottom portion 114 along a vertical axis VA of the automotive repair assist cart 100. In an exemplary embodiment, the base 116 comprises wheels attached to a bottom thereof (e.g., at the cart bottom portion 114). The cart frame 102 additionally comprises a handle end portion 120 and an fluid retention tank end portion 122 spaced apart along a longitudinal axis LA of the cart frame. The handle end portion 120 comprises a handle 121 configured to be comfortably gripped by a user for moving the automotive repair assist cart 100. The fluid retention tank end portion 122, as will be explained in greater detail below, is configured for mounting the oil drain tank assembly 104 thereto. Furthermore, the cart frame 102 has a front side 124 and a rear side 126. In various embodiments, the automotive repair cart 100 can have a side-by-side configuration wherein an overall with W of the cart 100 that comprises the width of the cart frame 102 plus the width of the removable parts washer 106 mounted on a side the cart 100 (e.g., the front side 124 or the rear side 126), as exemplarily illustrated in FIG. 6. In various embodiments, the cart frame 102 can comprise first, second, and third vertical legs 118, with the first vertical leg on the handle end portion 120, the second vertical leg on the rear side 126, and the third vertical leg on the front side 124.

In an exemplary embodiment, the cart frame 102 further comprises one or more additional trays 110 configured for storing at least one of oil changing equipment and materials thereon. The additional trays 110 are configured to be mounted to at least one of the vertical legs 118. It is envisioned that a height of one or more additional tray 110 can be adjusted along the vertical leg(s) 118 to permit flexibility of storage space. It is also contemplated that one or more of the additional trays 110 can comprise one or more organizer shelves configured for organizing the automotive repair equipment, e.g., oil changing equipment, thereon. For example, the additional trays 110 can comprise organizer shelves for organizing oil filters thereon. Moreover, the cart frame 102 can comprise a plurality of tool holders 128 configured thereon for holding a plurality of automotive repair tools. The tool holders 128 can comprise magnetic bars, hooks, compartments, slots, and/or notches, etc., mounted or configured on various components of the automotive repair assist cart 100 such as the vertical legs 118, drain tray 108, base 116, and/or handle 121. Additionally, the cart frame 102 can comprise a waste receptacle holder 130 configured for removably retaining a waste receptacle 131 on the automotive repair assist cart 100. In an exemplary embodiment, the waste receptacle holder 130 is located at the handle end portion 120 between the handle 121 and drain tray 108.

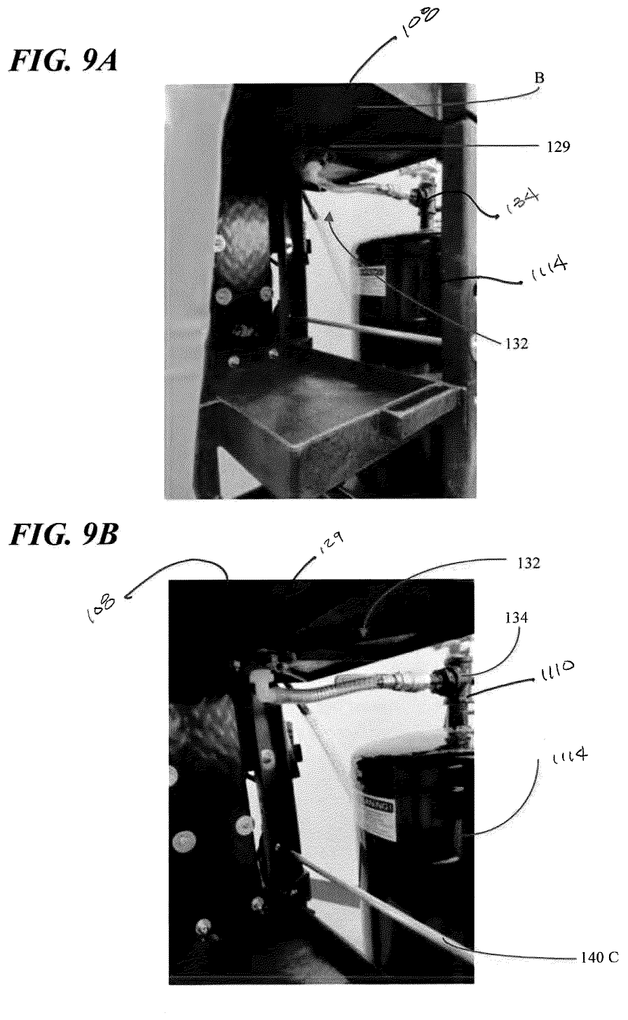

The drain tray 108 provides a contained space on the cart frame 102 for setting dirty tools and parts therein. The drain tray 108 is mounted to at least one of the vertical legs 118 at the cart top portion 112, above the additional trays 110. The drain tray 108 comprises a tray bottom B and a tray rim R standing up from the tray bottom. The tray bottom B comprises a drain tray drain 129 extending therethrough. As shown in FIGS. 9A and 9B, a drain tray coupler assembly 132 couples to the drain tray drain 129 at the tray bottom B at one end and couples to a fluid fitting 134 of the oil drain tank assembly 104 at an opposing end. In an exemplary embodiment, the fluid fitting 134 comprises a T-fitting connected to the oil drain tank assembly 104 and drain tray coupler assembly 132. Accordingly, oil from the dirty tools and parts disposed in the drain tray 108, can drain from the drain tray 108 through the drain tray drain 129, drain tray coupler assembly 132 and into a fluid retention tank 1114 of the oil drain tank assembly 104.

In an exemplary embodiment, the drain tray coupler assembly 132 comprises fittings, tubing, a ball valve, hose barbs, a tee, a bushing, a nipple, and a drain flange installed under the drain tray 108 for connecting the drain tray drain 129 to the fluid retention tank 1114 of the oil drain tank assembly 104. In an exemplary embodiment, the tray bottom B comprises one or more grooves 136 configured for guiding fluid (e.g., oil) in the drain tray 108 to the drain tray drain 129. Furthermore, one or more magnets 138 can be removably mounted to the drain tray 108 adjacent and proximate to the drain tray drain 129 to catch and prevent ferromagnetic debris from entering the drain tray drain 129. In one example, the magnets 138 are configured to removably couple to the drain tray 108 by magnetically coupling to metal fasteners (e.g., screws) used for installing the drain tray coupler assembly 132 to the drain tray drain 129.

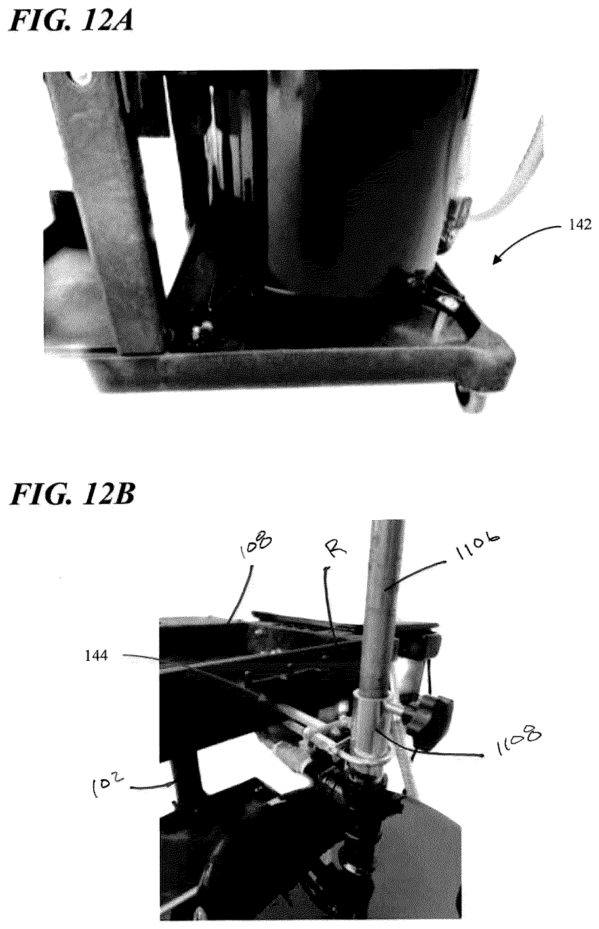

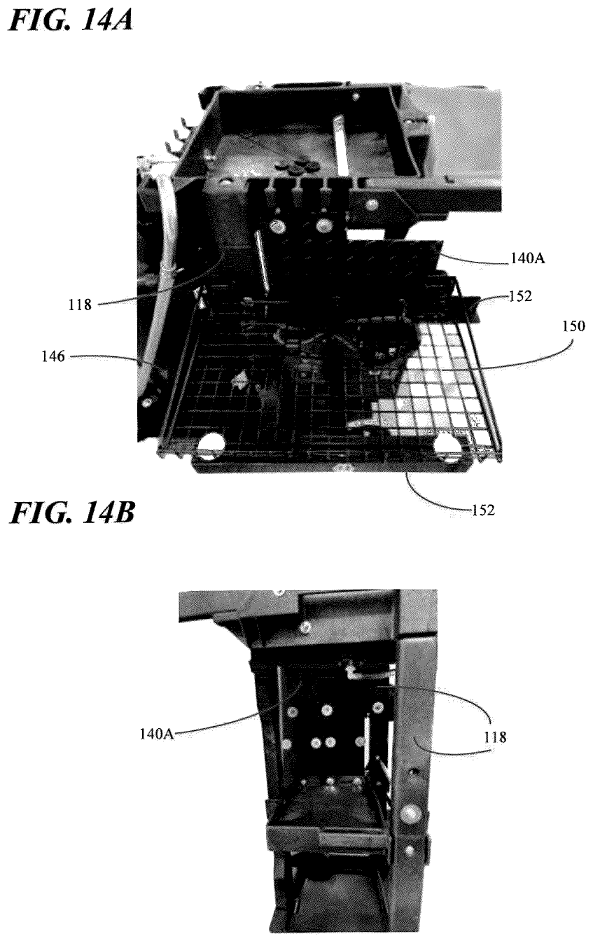

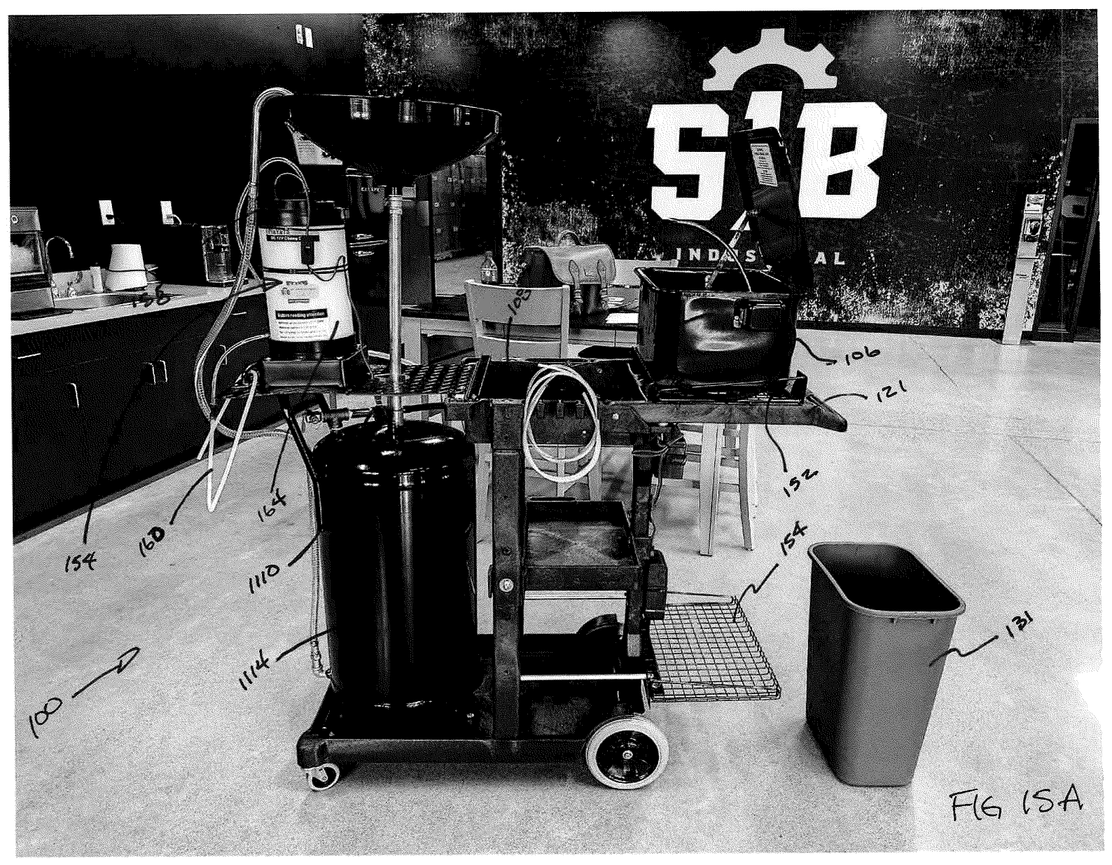

The automotive repair assist cart 100 further comprises additional structure added to the cart to improve stability and stiffness of the cart frame 102, thus making the automotive repair assist cart 100 more rigid. The additional structure comprises a plurality of stiffeners 140 and fasteners configured for reinforcing the automotive repair assist cart 100. For example, the stiffeners 140 include retention or mounting plates 140A, brackets 140B, and tension rods 140C. The stiffeners 140 are configured to provide additional support for the automotive repair assist cart 100 to support components such as the oil drain tank assembly 104, fluid retention tank mount 142 (FIG. 12A), drain pan assembly mount 144 (FIG. 12B), removable parts washer 106, and parts washer mount 146 (FIG. 14A).

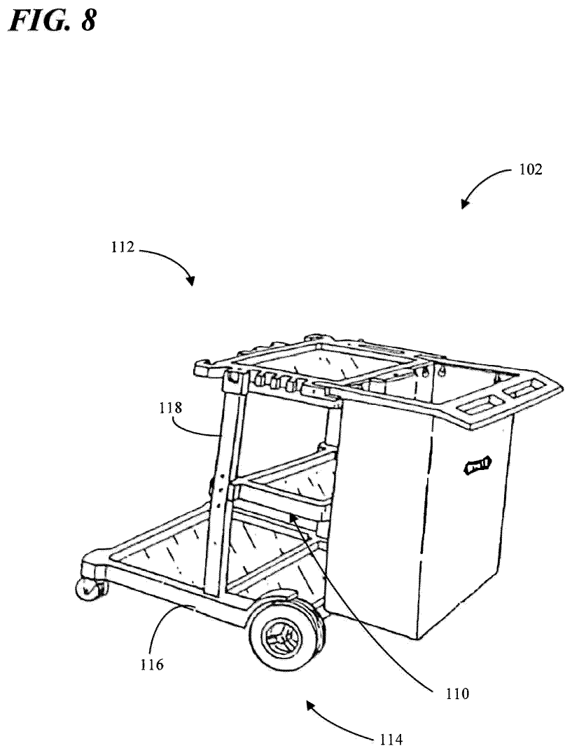

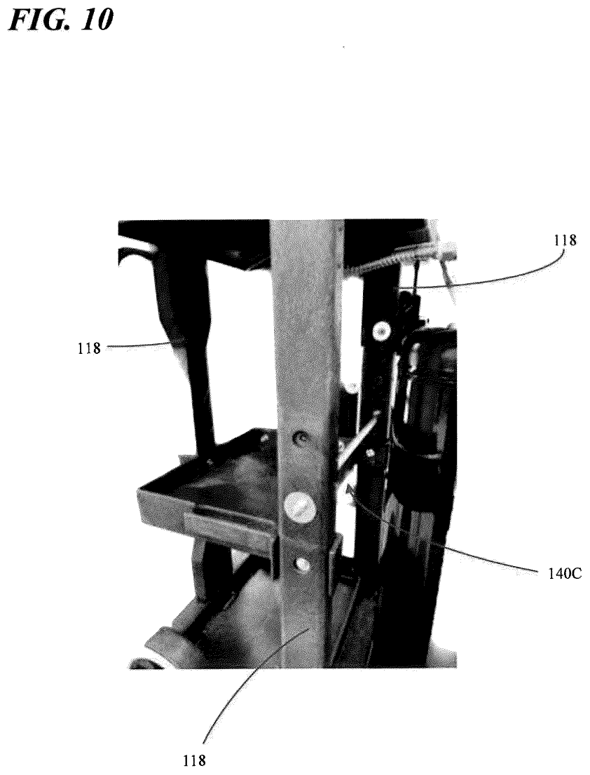

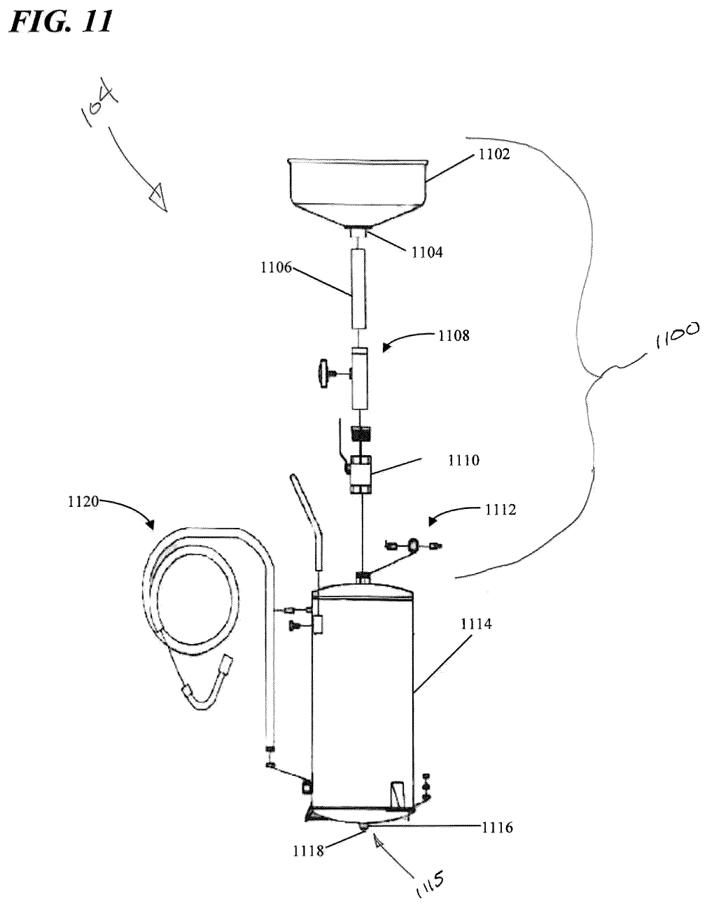

Referring now to FIGS. 1 through 11, in various embodiments the oil drain tank assembly 104 is mounted to the base 116 at the fluid retention tank end portion 122 of the cart frame 102 via the fluid retention tank mount 142 (FIG. 12A). The oil drain tank assembly 104 comprises a drain pan assembly 1100 configured to catch oil drained from a vehicle (e.g., when the automotive repair assist cart 100 is positioned under the vehicle) and the fluid retention tank 1114 coupled to the drain pan assembly 1100 with the fluid fitting 134 such that oil from the oil drain pan assembly 1100 drains into the fluid retention tank 1114 for containing the oil therein. In various embodiments, the drain pan assembly 1100 comprises a drain pan 1102 including a drain 1104, a height adjustable drain tube 1106, a height adjuster 1108, and a flow valve 1110. In one example, the flow valve 1110 is operably coupled to the drain 1104 to control oil flow therefrom, however it will be apparent to one of ordinary skill in the art, that the flow valve 1110 can be coupled to other components of the drain pan assembly 1100 to control oil flow therethrough. In various embodiments, the height adjustable drain tube 1106 is coupled to the flow valve 1110 such that oil from the drain pan 1102 will drain into the height adjustable drain tube 1106. The height adjuster 1108 is operably coupled to the height adjustable drain tube 1106 to adjust a height of the height adjustable drain tube 1106, thereby adjusting a height of the drain pan 1102. The height adjuster 1108 is also coupled to the flow valve 1110 such that oil from the drain pan 1102 will controllably drain into the fluid retention tank 1114 based on an Open or Closed status of the flow valve 1110.

In various embodiments, the fluid retention tank 1114 can comprise a 20-gallon fluid retention tank configured for containing oil therein. It should be understood that the fluid retention tank 1114 can be configured and sized as desired without departing from the scope of the present disclosure. Furthermore, the fluid retention tank 1114 comprises an oil dispensing assembly 1115 configured for dispensing the oil contained therein. In various embodiments, the oil dispensing assembly comprises an fluid retention tank drain 1116 and a plug 1118 for the fluid retention tank drain 1116, such that when the plug 1118 is removed, oil from the fluid retention tank 1114 can drain therefrom. In this instance, the cart frame 102 can be configured with a drain hole in the base 116 at the fluid retention tank end portion 122, such that when the plug 1118 is removed, oil from the fluid retention tank 1114 drains through the fluid retention tank drain 1116 and drain hole in the cart frame. Accordingly, the automotive repair assist cart 100 can be positioned over an oil disposal repository whereafter that the oil can drain through the fluid retention tank drain 1116 and drain hole in the cart frame 102 into the oil disposal repository.

In various embodiments, the oil dispensing assembly can further comprise a pressurizing assembly 1112 operably coupled to the fluid retention tank 1114 and a discharging line 1120 operably coupled to the fluid retention tank 1114. The pressurizing assembly 1112 is configured to pressurize the fluid retention tank 1114 to dispense oil from the fluid retention tank 1114 through the discharging line 1120. In this instance, at least one of the tool holders 128 of the cart frame 102 can be configured as a discharging line holder for holding the discharging line 1120. In various embodiments, the pressurizing assembly 1112 can comprise a regulator, gauge, safety valve, and air inlet connector.

FIG. 12A illustrates an exemplary fluid retention tank mount 142 configured for mounting the fluid retention tank 1114 to the base 116 at the fluid retention tank end portion 122 of the cart frame 102. In various embodiments, the fluid retention tank mount 142 is configured to mount the fluid retention tank 1114 to the automotive repair assist cart 100 at four contact points. For example, two contact points are mounted using three carriage bolts, eight washers, two thread couplers used as spacers, and two hex nuts. The other two contact points are mounted using two rubber insulated clamp straps using two hex bolts, four washers, and two nuts. FIG. 12B illustrates an exemplary drain pan assembly mount 144 configured for mounting the drain pan assembly 1100 to at least one of the cart frame 102 and drain tray 108. In various embodiments, the drain pan assembly mount 144 comprises a brace connecting the drain pan assembly height adjuster 1108 to a portion of the cart frame 102 and/or the drain tray 108. The brace stabilizes the height adjuster 1108 and therefore stabilizes the drain pan assembly 1100 on the automotive repair assist cart 100. In various embodiments, the brace mounts to the rim R of the drain tray 108 and the height adjuster 1108 that is connected to the height adjustable drain tube 1106. In various embodiments, the brace can comprise a U bolt, an all thread, a sleeve, hex nuts, flat washers, and an angle. Each of the fluid retention tank mount 142 and drain pan assembly mount 144 are configured for securing and stabilizing the oil drain tank assembly 104 on the automotive repair assist cart 100.

Referring now to FIGS. 1 through 13, the removable parts washer 106 is configured for washing parts therein. In various embodiments, the removable parts washer 106 comprises a 3-gallon bench top parts washer. It should be understood that the removable parts washer 106 can include a bench top parts washer sized and configured as desired without departing from the scope of the present disclosure. Broadly the removable parts washer 106 comprises a cleaning fluid tub 1301, a washer system 1320 disposed in the tub 1301, an electrical coupler, and an actuating mechanism or switch 1316 mounted on an exterior of the tub 1301. The washer system 1320 comprises a pump 1306 operably connected to a spigot for pumping fluid contained in the tub 1301 therethrough for washing a part contained in the tub 1301. In various embodiments, the electrical coupler is configured to couple to a DC battery power source 148 mounted on the automotive repair assist cart 100) such that the DC battery power source will provide electrical power to the washer system 1320. Alternatively, in various embodiments, the electrical coupler can be configured to couple to a 120V AC shore power source (e.g., a 120V AC wall outlet). The actuating mechanism or switch 1316 is configured for selectively controlling power provided from the power source to the washer system 1320. Particularly, in various embodiments, the removable parts washer 106 comprises a tank or tub 1301, a lid 1302, a removable shelf 1303, two linked lid arms 1304, two safety plates 1305, a pump 1306, a rivet 1307, a pump holder 1308, a flexible metal spigot 1309, four plastic plates 1310, an M5X30 screw 1311, an M5 nut 1312, a cover 1313, three M4X12 screws 1314, a handle 1315, a switch 1316, strain relief 1317, and a power cord 1318 (e.g., electrical coupler).

In various embodiments the pump 1306 can be configured to operate via a 120 V AC power source, in which case the power cord 1318 can be plugged into the external power 120V AC power source such as a standard wall outlet. In other embodiments the pump 1306 can be configured to operate via a DC battery source such as the DC power source 148 mounted on the automotive repair assist cart 100. The power source 148 can be structured and operable to provide any desired DC voltage, e.g., 12V, 24V, 48V etc. In one embodiment, the battery and power source 148 is mounted on the retention plate 140A on the rear side 126 of the automotive repair assist cart 100. In various other embodiments, the battery and power source 148 can be mounted in any suitable location of the cart 100 and to any suitable structure, component, assembly, apparatus, etc., of the cart 100. In various embodiments, the power source 148 can include a battery and a charger (e.g., a smart charger) 148 such as a 20A 12V/24V/48V battery charger and maintainer. In various embodiments, the power source 148 (e.g., the battery and charger) are mounted on the retention plate 140A with a quick disconnect for the wiring. This allows for quick removal of the power source 148. In other exemplary embodiments, the power source 148 comprises a 12V battery configured to provide power to the removable parts washer 106.

Referring now to FIGS. 14A and 14B, the removable parts washer 106 is configured to be supported on the automotive repair assist cart 100 via the parts washer mount 146. The parts washer mount 146 is mounted to at least one of the vertical legs 118 and the retention plate 140A on the rear side 126 of the automotive repair assist cart 100. In various embodiments, the parts washer mount 146 comprises a parts washer tray 150 and a bracket assembly 152. In various embodiments the parts washer tray 150 can comprise a shelf, and the bracket assembly 152 can comprise an angle with a strap brace. The bracket assembly 152 is mounted to the automotive repair assist cart 100 at a vertical leg 118 and the retention plate 140A. The parts washer tray 150 is secured to the bracket assembly 152. In various embodiments, the angle of the bracket assembly 152 comprises an aluminum angle that is mounted to the cart with two hex bolts, nuts, and four washers. The angle assembly is then mounted the retention plate 140A.

A method of assembling the automotive repair assist cart 100 will now be described. Prior to the assembly, the individual components of the automotive repair assist cart 100 are formed and assembled.

The method begins by providing the cart frame 102 comprising the base 116 with the plurality of vertical legs 118 extending therefrom towards the cart top portion 112. Moreover, the cart frame 102 comprises the handle end portion 120 (comprising handle 121) and the fluid retention tank end portion 122 spaced apart along the longitudinal axis LA of the cart frame. The cart frame 102 also comprises the front side 124 and the rear side 126 spaced apart along the width W of the cart frame. In an exemplary embodiment, the cart frame 102 comprises one or more additional trays 110 with organizer shelves thereon. Next, the drain tray 108 comprising the tray bottom B, tray rim R, and drain tray drain 129 is mounted to at least one of the vertical legs 118 at the cart top portion 112. In various embodiments, the drain tray 108 is configured with components such as the tool holders 128, drain tray drain 129, grooves 136, and bracket 140B prior to mounting the drain tray on the cart frame 102. From here, the automotive repair assist cart 100 is reinforced with one or more stiffeners 140, so that the automotive repair assist cart can stably and securely support additional components thereon.

Once the automotive repair assist cart 100 is properly reinforced, the fluid retention tank mount 142, drain pan assembly mount 144, and parts washer mount 146 are mounted on the cart frame 102. For example, the fluid retention tank mount 142 is mounted to the base 116 at the fluid retention tank end portion 122, the drain pan assembly mount 144 is mounted to the drain tray 108 at the rim R, and the parts washer mount 146 is mounted to the retention plate 140 and vertical leg 118 on the rear side 126 of the automotive repair assist cart 100. Next, the fluid retention tank 1114 is mounted to the base 116 at the fluid retention tank end portion 122 via the fluid retention tank mount 142, and the drain pan assembly is mounted to the cart frame 102 with the drain pan assembly mount 144. In one embodiment, the power source 148 for connecting the removable parts washer 106 thereto is mounted to the retention plate 140A below the parts washer mount 146. The removable parts washer 106 is then placed on the parts washer mount 146.

A method of using the automotive repair assist cart 100 for performing an oil change on a vehicle will now be described. Prior to executing the method, the vehicle is prepped for the oil change. For example, the engine oil dipstick is removed from the vehicle, the parking break is engaged, the vehicle is raised above the ground with a car lift, and pre-process safety procedures are performed.

Initially, a user (e.g., a mechanic performing the oil change) can wheel the automotive repair assist cart 100 underneath the vehicle to position the drain pan 1102 under the vehicle's engine oil drain pan. Using the height adjuster 1108, the user can adjust the height of the drain pan 1102 to bring it closer to or farther from the engine oil drain pan. Once the drain pan 1102 is properly positioned to catch oil drained from the engine oil drain pan, the user can remove a drain plug of the engine oil drain pan such that old oil from the vehicle drains into the drain pan 1102, through the drain pan assembly 1100, and into the fluid retention tank 1114. While the old oil is draining from the engine oil pan, the user can begin cleaning parts such as the drain plug of the engine oil pan. To clean the parts, the user can place the parts in the drain tray 108, so that oil on the parts can drain into the fluid retention tank 1114. Moreover, the parts can be placed in the removable parts washer 106 and the user can plug the electrical coupler into the power source and actuate the actuating mechanism for turning on the washer system for washing the parts. Once the oil has finished draining the cleaned parts can be replaced.

Next, the automotive repair assist cart 100 is positioned under the vehicle's oil filter, to catch oil remaining in the oil filter. The user can loosen the oil filter or oil filter cap so that oil drains from the oil filter into the drain pan 1102. Furthermore, the user can remove the oil filter and place it in the drain tray 108. Next, a user installs a new oil filter (e.g., stored on the additional trays 110) on the vehicle. To finish up the oil change, the user can add new oil to the vehicle, reinstall removed parts, and perform further safety and quality processes. After performing the oil change or after performing several oil changes, the automotive repair assist cart 100 can be moved to an oil disposal assembly. Here, old oil contained in the fluid retention tank 1114 is drained into the oil disposal assembly using the oil dispensing assembly of the fluid retention tank 1114. Moreover, the removable parts washer 106 can be removed from the automotive repair assist cart 100, so that fluid and debris contained therein can be properly disposed of.

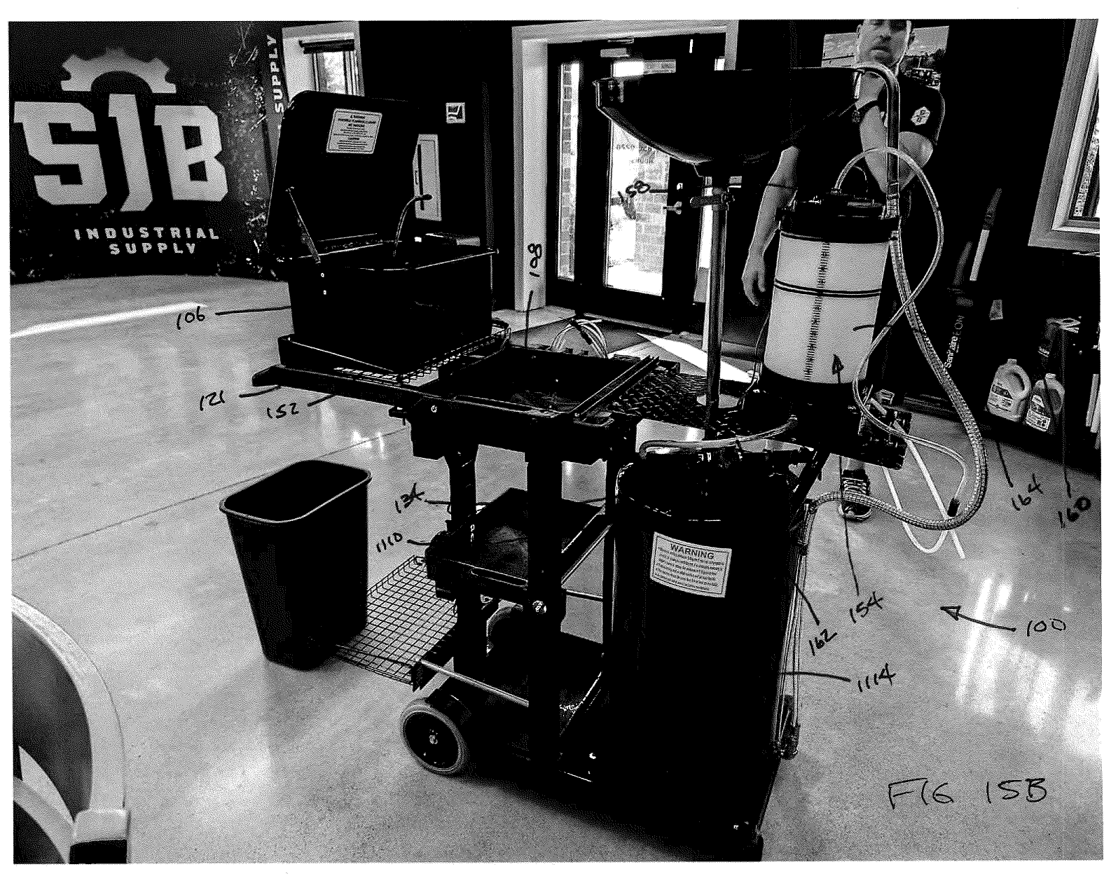

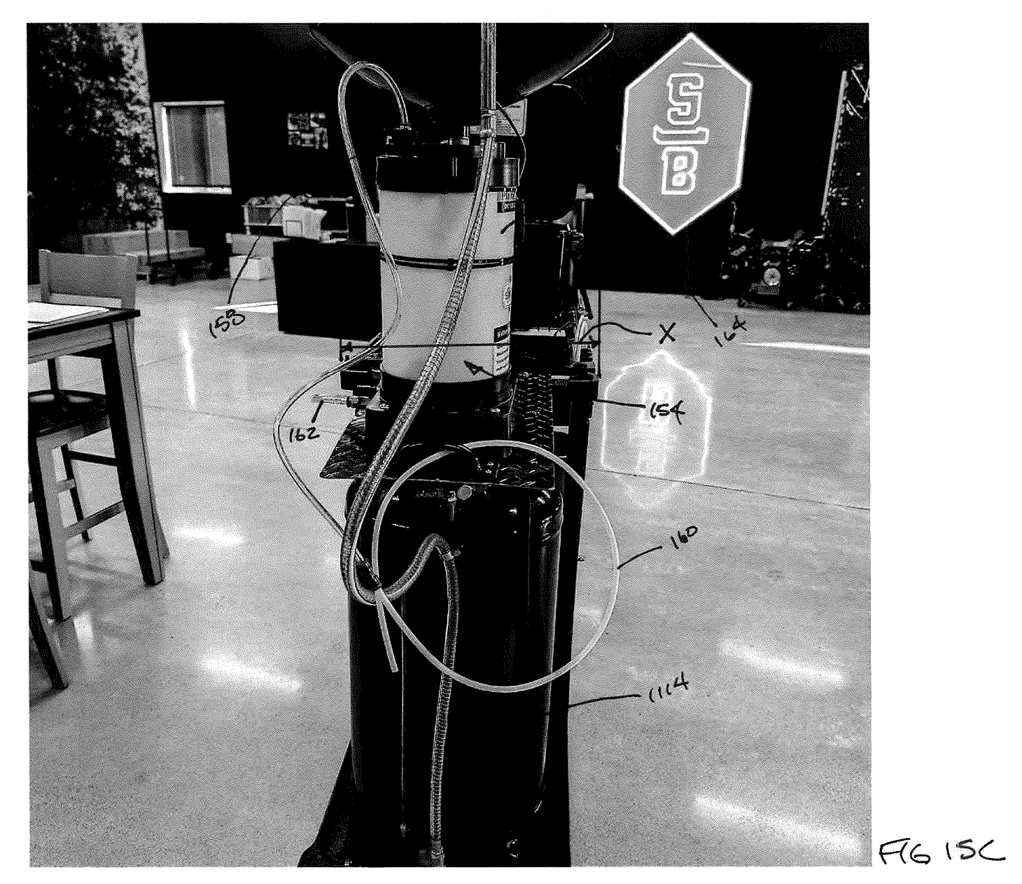

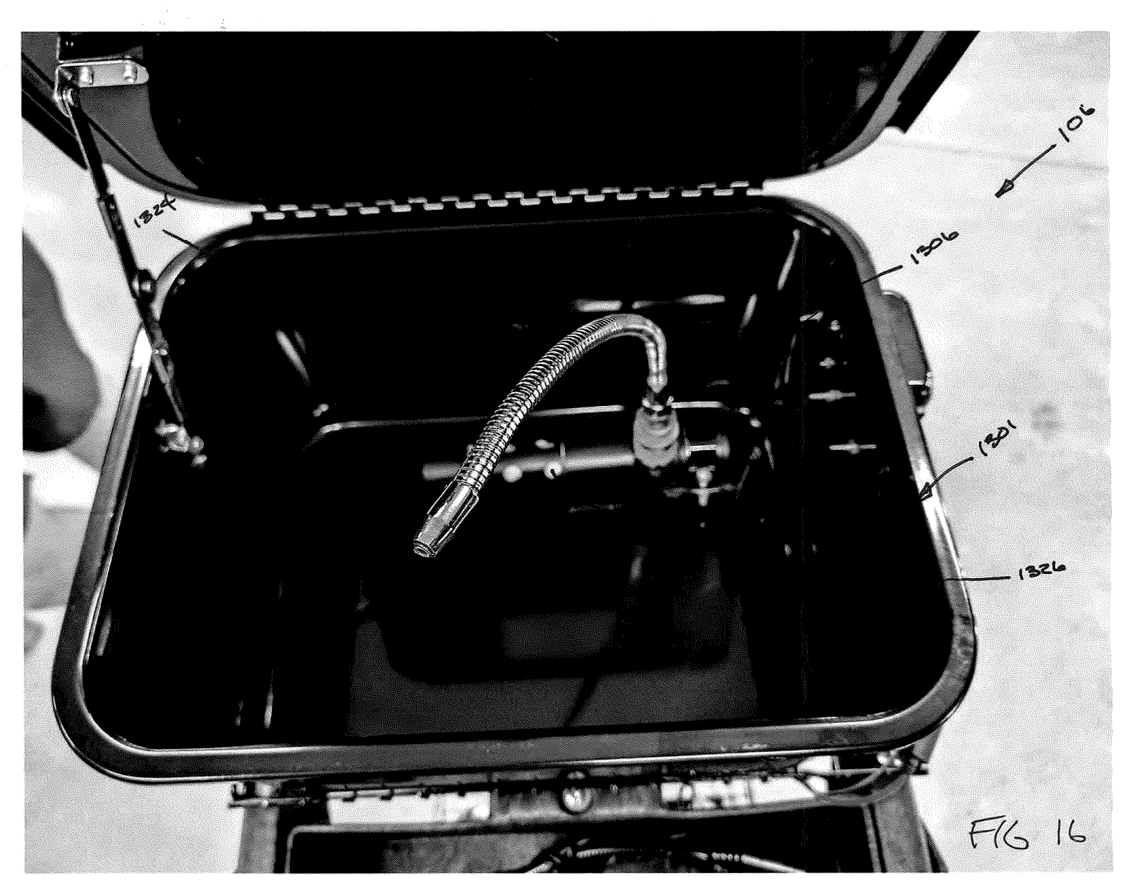

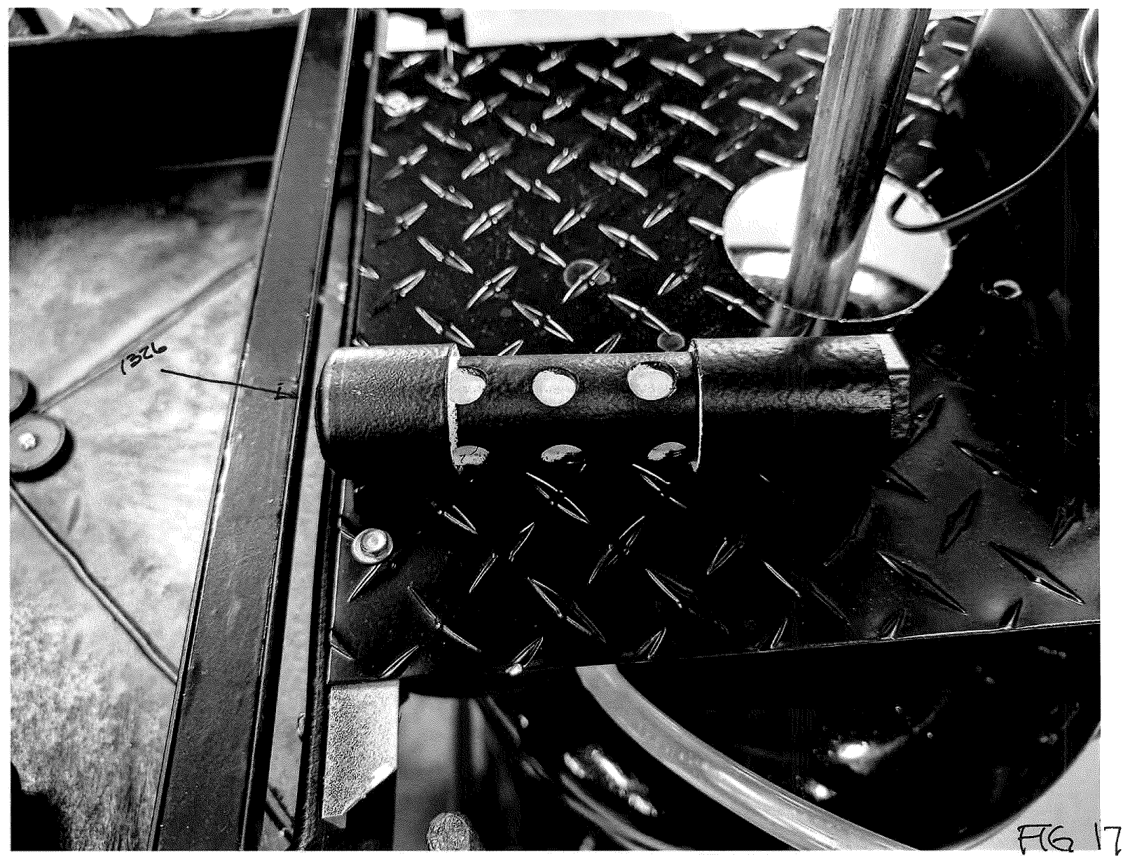

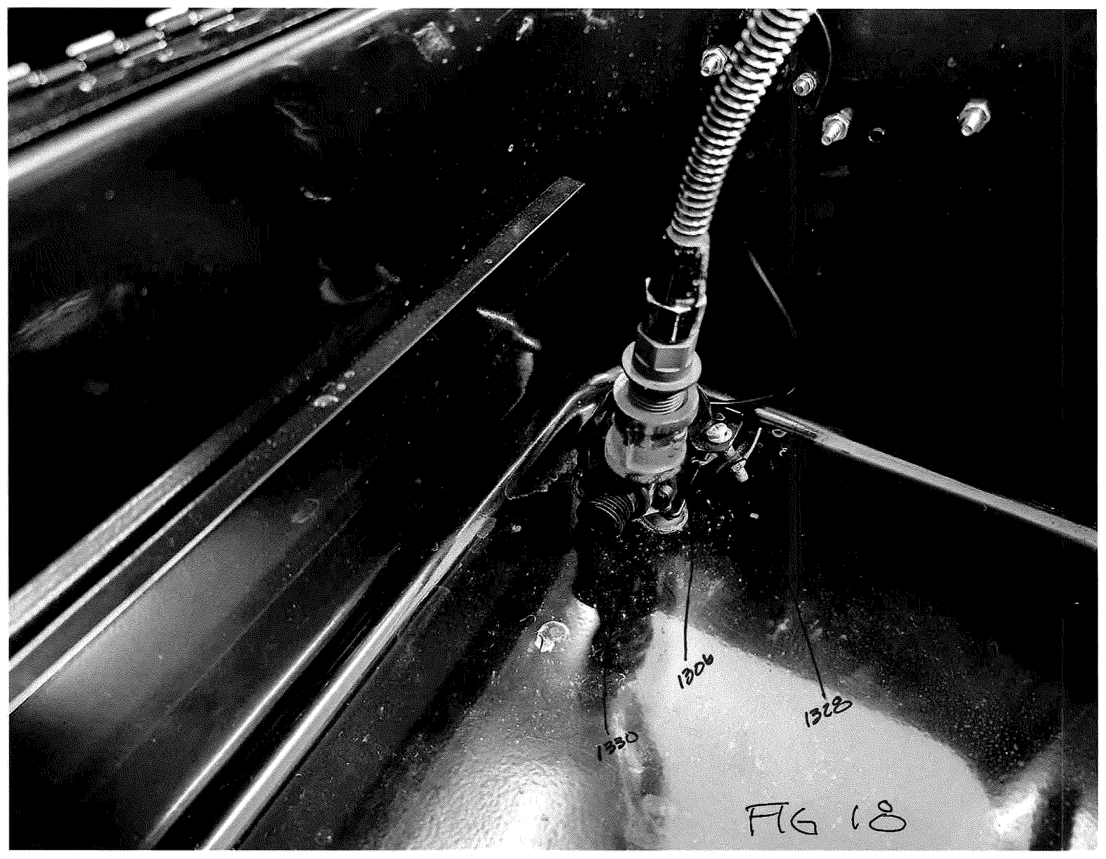

Referring now to FIGS. 1 through 14B and further to FIGS. 15A through 20, in various embodiments the automotive assist cart 100 can have an in-line configuration wherein the removable parts washer is mounted to a platform 152 connected to the cart handle 121 and disposed in-line with the drain tray 108 and the fluid retention tank assembly 104 along a longitudinal axis Z (see FIG. 6) of the cart 100, as exemplarily illustrated in FIGS. 15A, 15B and 15C. This in-line configuration allows the automotive assist cart 100 to pass through and/or be positioned for use in narrower spaces, thereby increasing the ease of use and minimizing the concern of striking an object (e.g., an automobile) when the cart 100 moved between and/or positioned between two objects (e.g., two automobiles). In such embodiments, the waste receptacle 131 can be a rigid or semi-rigid sided container disposed on and/or removably connected to a waste receptacle platform 154 that is located below the handle 121 and along the longitudinal axis Z.

In various embodiments, the automotive repair cart 100 can further comprise a fluid extractor 154 that is structured and operable to extract, via a vacuum, fluids (e.g., engine oil, transmission fluid, differential fluid, power steering fluid, brake fluid, etc.) from a vehicle. In various embodiments, the fluid extraction 154 can be mounted in-line with the drain tray 108 and the fluid retention tank assembly 104, and in various instances the removable parts washer 106, along the longitudinal axis Z of the cart 100, as exemplarily illustrated in FIGS. 15A, 15B and 15C. For example, in various embodiments, the fluid extractor 154 can be mounted (removably or fixedly) to an extractor platform 156 extending from a front side of the drain tray 108 and forward of the drain pan assembly 1100. The fluid extractor 154 generally comprises a fluid receptacle 164, a pump 158, an extraction hose or tube 160, and a discharge hose or tube 162. The pump 158 is physically and fluidly connected to a top of the fluid receptacle 164. The extractor hose/tube 160 is physically and fluidly connected to the pump 158 at a first end and is open to the ambient environment at an opposing second end. The discharge hose/tube 162 is physically and fluidly connected to bottom of the fluid receptacle 164 (e.g., via a controllable valve) at a first end and is fluidly connected to the fluid retention tank 1114 and an opposing second end (e.g., via the fluid fitting 134 and flow valve 1110). In various embodiments, the pump 158 is structured to operate using a 120 V AC supply (e.g., a wall outlet). In other embodiments, the pump 158 is structured to operate using a 12V, 24V, 48V, etc., DC battery power source such as the DC power source 148. In operation, the extraction hose/tube 160 can be inserted into a fluid retention compartment of an automobile (e.g., the oil pan, the transmission, the differential, power steering fluid reservoir, brake master cylinder, etc.), whereafter the pump 158 is activate to withdraw the fluid, via a vacuum, from the fluid retention compartment and deposit the withdrawn fluid in the extractor fluid receptacle 164. Subsequently, the fluid removed from the automobile fluid retention compartment and deposited into the extractor fluid receptacle 164 can be drained via gravity of pumped via the extractor pump 158 into the fluid retention tank 1114 via the discharge hose/tube 162.

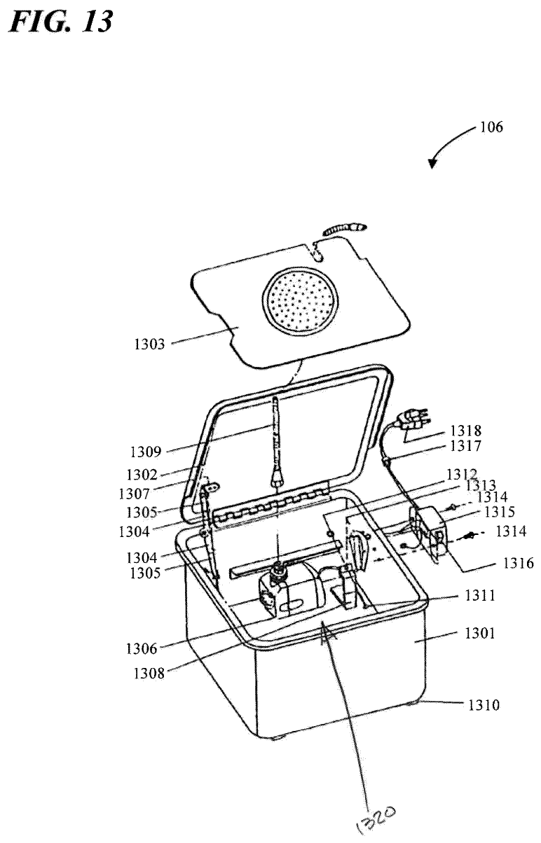

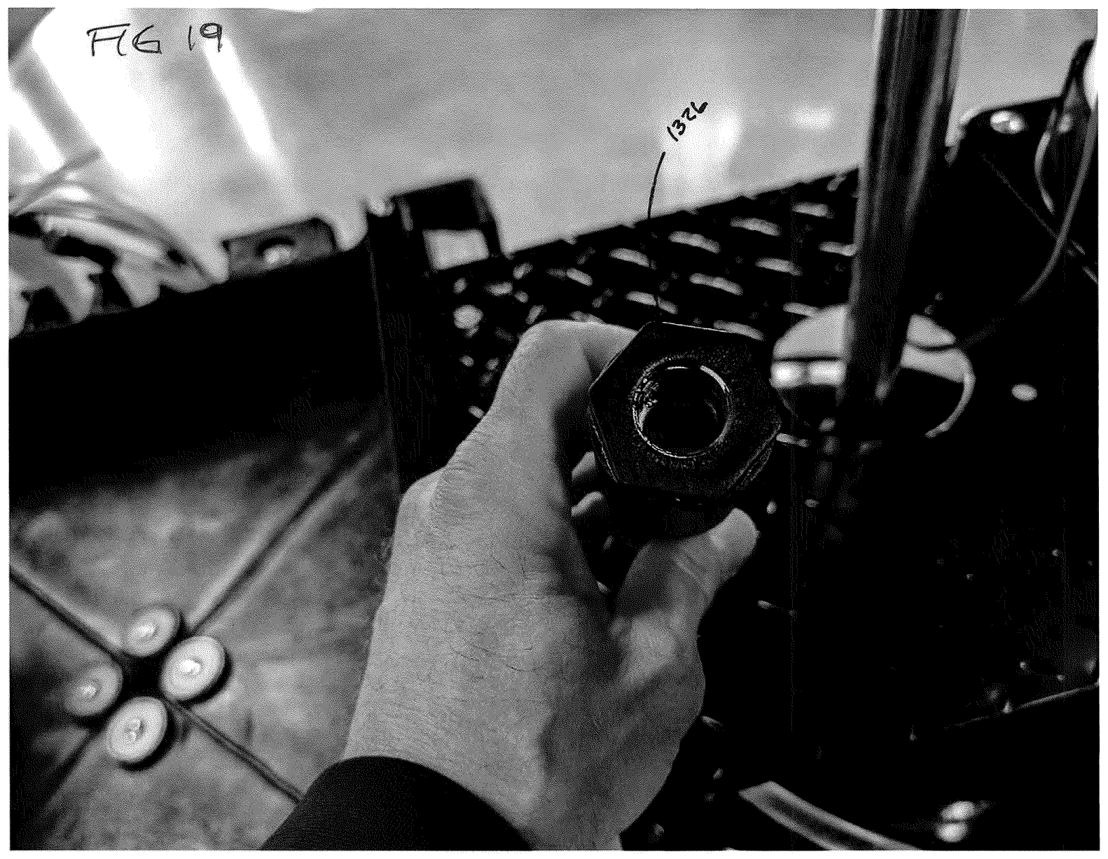

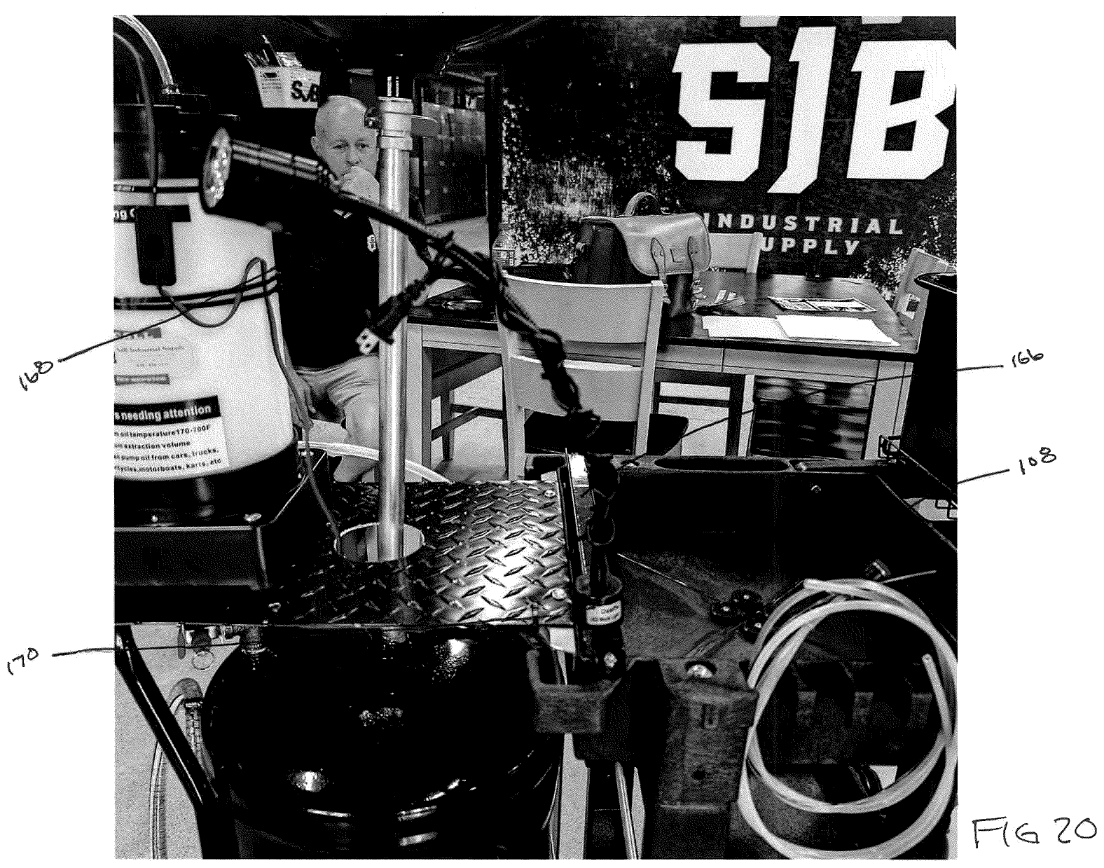

Referring now to FIGS. 13, 16, 17, 18 and 19, as described above, the removable parts washer 106 generally comprises a cleaning fluid tub 1301 and a cleaning fluid pump 1306. In various embodiments, the parts washer 106 additionally comprises a fluid return spout 1324 physically (e.g., removably or fixedly) and fluidly connected to an output port 1328 of the pump 1306, and a replaceable cleaning fluid filter 1326 removably connected to an intake port 1330 of the pump 1306. The cleaning fluid filter 1326 is structured and operable to filter, clean and remove debris and particulates from parts cleaning fluid disposed within the tub 1301 as the pump 1306 intakes the parts cleaning fluid from within the cleaning fluid tub 1301, and the fluid return spout 1324 is structured and operable to direct the filtered and cleaned parts washing fluid output by the pump 1306 back into the cleaning fluid tub 1301, thereby cleaning and circulating the parts cleaning fluid. The replaceable cleaning fluid filter 1326 can be removably coupled or connected to the cleaning fluid pump intake port 1330 via and suitable removably connecting device, apparatus, means or method. For example, in various embodiments, the cleaning fluid filter 1326 can be threadedly removably connectable to the intake port 1330 as exemplarily illustrated in FIGS. 18 and 19. Alternatively, it is envisioned that the cleaning fluid filter 1326 can be removably connectable to the intake port 1330 via a partial-turn spring-biased mating between the cleaning fluid filter 1326 and the intake port 1330, or a clamping system wherein the filter 1326 is clamped to the intake port 1330, or any other removably connecting device, apparatus, means or method suitable for removably connecting the cleaning fluid filter 1326 to the cleaning fluid pump intake port 1330.

Referring now to FIG. 20, in various embodiments, the automotive repair assist cart 100 can further include one or more magnetic tool retention bar 166 that is structured and operable to magnetically retain metallic tools (e.g., many common automotive repair hand tools such as wrenches, screw drivers, sockets, etc.) The magnet tool retention bar(s) can be located in any suitable location of the cart 100 and to any suitable structure, component, assembly, apparatus, etc., of the cart 100. For example, in various embodiments, the magnetic tool retention bar 166 can be mounted to cart 100 on or near a wall of the drain tray 108. Additionally, in various embodiments, the automotive repair assist cart 100 can still further comprise a light fixture 168 that is structured and operable to assist an automotive repair operator by projecting light where desired. In various instances, the light fixture 168 can be a flexible neck LED light fixture that can be easily adjusted to direct the light where needed. Additionally, in various embodiments, the light fixture 168 can be removably connectable light fixture having a retention base 170 that is structured and operable to removably connect and retain the light fixture 168 at any suitable and convenient location on the cart 100. The retention base 170 can be any base that is suitable to removably connect and retain the light fixture 168 at any suitable and convenient location on the cart 100, such as a magnetic disc, bar, block or cylinder, or a spring biased clip, or a ratcheting clamp, etc.

It should be noted that, as described above, in various embodiments, the automotive repair assist cart 100 is entirely battery powered and operated, and free of any power supply cords (e.g., 120V AC power cords) that need to be disposed on a floor and extend across the floor to connect to 120V AC shore power supply (e.g., a 120 V AC wall outlet), thereby allowing for easy, free and unencumbered movement and placement of the automotive repair assist cart 100. More particularly, the automotive repair assist cart 100 includes the DC battery and a charger 148 that are structured and operable to provide DC power (e.g., 12V, 24V, 48V, etc.) to all electrically operated components, devices, apparatus and systems of the automotive repair assist cart 100 described herein.

Having described the invention in detail, it will be apparent that modifications and variations are possible without departing from the scope of the disclosure defined in the appended claims. For example, where specific dimensions are given, it is understood these dimensions are illustrative and other dimensions are within the scope of the present disclosure.

In view of the above, it will be seen that the several objects of the disclosure are achieved and other advantageous results attained. As various changes could be made in the above products and methods without departing from the scope of the disclosure, it is intended that all matter contained in the above description shall be interpreted as illustrative and not in a limiting sense.

What is claimed is

1. An automotive repair assist cart configured for performing an oil change on a vehicle, the automotive repair assist cart comprising:
a cart frame comprising a base with a plurality of vertical legs extending therefrom toward a cart top portion, the cart frame comprising a handle end portion and an fluid retention tank end portion spaced apart along a longitudinal axis of the cart frame;
an oil drain tank assembly mounted to the base at the fluid retention tank end portion of the cart frame, the oil drain tank assembly comprising a drain pan assembly configured to catch oil drained from the vehicle and an fluid retention tank coupled to the drain pan assembly with a fluid fitting such that the oil from the drain pan assembly drains into the fluid retention tank for containing the oil therein; and
a drain tray mounted to at least one of the vertical legs at the cart top portion, the drain tray comprising a tray bottom and a tray rim standing up from the tray bottom, the tray bottom comprising a drain tray drain coupled to the fluid retention tank with a drain tray coupler assembly.

2. The automotive repair assist cart of claim 1, wherein the drain pan assembly comprises a drain pan including a drain, a height adjustable drain tube, a height adjuster, and a flow valve, the flow valve being operably coupled to the drain to control oil flow, the height adjustable drain tube coupled to the flow valve such that oil from the drain pan is configured to drain into the height adjustable drain tube, the height adjuster being operably coupled to the height adjustable drain tube to adjust a height of the height adjustable drain tube, thereby adjusting a height of the drain pan and flow valve coupled thereto, the height adjuster coupled to the fluid fitting such that the oil from the drain pan is configured to drain into the fluid retention tank.

3. The automotive repair assist cart of claim 1, further comprising a drain pan assembly mount configured for mounting the drain pan assembly to at least one of the cart frame and drain tray.

4. The automotive repair assist cart of claim 1, further comprising an fluid retention tank mount configured for mounting the fluid retention tank to the base at the fluid retention tank end portion of the cart frame.

5. The automotive repair assist cart of claim 1, wherein the fluid retention tank comprises an oil dispensing assembly configured for dispensing oil contained in the fluid retention tank.

6. The automotive repair assist cart of claim 5, wherein the cart frame comprises a drain hole in the base at the fluid retention tank end portion, and wherein the oil dispensing assembly comprises an fluid retention tank drain and a plug for the fluid retention tank drain, such that when the plug is removed oil from the fluid retention tank is configured to drain from the fluid retention tank through the fluid retention tank drain and drain hole into an oil disposal assembly.

7. The automotive repair assist cart of claim 5, wherein the oil dispensing assembly comprises a pressurizing assembly operably coupled to the fluid retention tank and a discharging line operably coupled to the fluid retention tank, the pressurizing assembly being configured to pressurize the fluid retention tank to dispense oil from the fluid retention tank through the discharging line, the discharging line being releasably contained on the automotive repair assist cart with a discharging line holder.

8. The automotive repair assist cart of claim 1, wherein the drain tray coupler assembly couples the drain tray drain to the fluid fitting for coupling the drain tray drain to the fluid retention tank.

9. The automotive repair assist cart of claim 8, wherein the drain tray coupler assembly is mounted to the tray bottom.

10. The automotive repair assist cart of claim 1, further comprising one or more magnets releasably mounted to the drain tray proximate the drain tray drain, the one or more magnets configured for catching ferromagnetic debris to prevent the ferromagnetic debris from entering the drain tray drain.

11. An automotive repair assist cart configured for performing an oil change on a vehicle, the automotive repair assist cart comprising:
a cart frame comprising a base with a plurality of vertical legs extending therefrom toward a cart top portion, the cart frame comprising a handle end portion and an fluid retention tank end portion spaced apart along a longitudinal axis of the cart frame, the cart frame comprising a front side and a rear side spaced apart along a width of the cart frame;
an oil drain tank assembly mounted to the base at the fluid retention tank end portion of the cart frame, the oil drain tank assembly comprising a drain pan assembly configured to catch oil drained from the vehicle and an fluid retention tank coupled to the drain pan assembly with a fluid fitting such that the oil from the drain pan assembly drains into the fluid retention tank for containing the oil therein;
a removable parts washer configured for washing parts therein; and
a parts washer mount configured for removably supporting the removable parts washer on the automotive repair assist cart, the parts washer mount being mounted to at least one of the vertical legs at the cart top portion on the rear side of the cart frame.

12. The automotive repair assist cart of claim 11, wherein the drain pan assembly comprises a drain pan including a drain, a height adjustable drain tube, a height adjuster, and a flow valve, the flow valve being operably coupled to the drain to control oil flow, the height adjustable drain tube coupled to the flow valve such that oil from the drain pan is configured to drain into the height adjustable drain tube, the height adjuster being operably coupled to the height adjustable drain tube to adjust a height of the height adjustable drain tube, thereby adjusting a height of the drain pan and flow valve coupled thereto, the height adjuster coupled to the fluid fitting such that the oil from the drain pan is configured to drain into the fluid retention tank.

13. The automotive repair assist cart of claim 11, further comprising an fluid retention tank mount configured for mounting the fluid retention tank to the base at the fluid retention tank end portion of the cart frame.

14. The automotive repair assist cart of claim 11, wherein the fluid retention tank comprises an oil dispensing assembly configured for dispensing oil contained in the fluid retention tank.

15. The automotive repair assist cart of claim 14, wherein the cart frame comprises a drain hole in the base at the fluid retention tank end portion, and wherein the oil dispensing assembly comprises an fluid retention tank drain and a plug for the fluid retention tank drain, such that when the plug is removed oil from the fluid retention tank is configured to drain from the fluid retention tank through the fluid retention tank drain and drain hole into an oil disposal assembly.

16. The automotive repair assist cart of claim 14, wherein the oil dispensing assembly comprises a pressurizing assembly operably coupled to the fluid retention tank and a discharging line operably coupled to the fluid retention tank, the pressurizing assembly being configured to pressurize the fluid retention tank to dispense oil from the fluid retention tank through the discharging line, the discharging line being releasably contained on the automotive repair assist cart with a discharging line holder.

17. The automotive repair assist cart of claim 11, wherein the cart frame comprises a plurality of tool holders configured thereon for holding a plurality of oil changing tools on the automotive repair assist cart.

18. The automotive repair assist cart of claim 11, further comprising one or more additional trays configured for storing at least one of oil changing equipment and materials thereon, each of the additional trays being mounted to at least one of the vertical legs.

19. The automotive repair assist cart of claim 18, wherein at least one of the one or more additional trays comprises an organizer shelf configured for organizing the oil changing equipment and materials thereon.

20. The automotive repair assist cart of claim 11, further comprising a retention plate mounted to the cart frame on the rear side, and wherein the parts washer mount comprises a parts washer tray mounted to the cart frame and the retention plate.
